(19) United States
(12) Patent Application Publication
(10) Pub. No.: US 2006/0163383 A1
(43) Pub. Date: Jul. 27, 2006

(54) Nozzle with a rotating jet

(76) Inventor: Stephane Guerineau, St Georges de Montaigu (FR)

Correspondence Address: YOUNG & THOMPSON, 745 SOUTH 23RD STREET, 2ND FLOOR, ARLINGTON, VA, 22202, US

(21) Appl. No.: 10/568,408

(22) PCT Filed: Aug. 11, 2004
(86) PCT No.: PCT/FR04/02132

§ 371 Date: Mar. 13, 2006

(30) Foreign Application Priority Data
Aug. 14, 2003 (FR) 0309944

(51) Int. Cl. B05B 3/04

(52) U.S. Cl. 239/237

(57) ABSTRACT

The invention relates to a nozzle (1) with a rotating jet, said nozzle consisting of a static body (2A) defining an open cavity (2B) containing an injector (2C). One end of the injector (2C) is driven in a circular movement about a pivot (2D) of the body (2A) under the effect of water pressure having a tangential flow rate and acting on the injector (2C), while the other end of said injector (2C) is provided with a spray nozzle (2E) and is arranged in the opening of the cavity (2B) in the form of a concave seat (2F) enabling the precession movements of the injector. The inventive nozzle is characterised in that the inner diameter (d1) of the spray nozzle (2E) measures between 2.8 and 6 mm while the smallest diameter (d2) of the seat (2F) measures between 4 and 11.5 mm, the smallest diameter (d2) of the seat (2F) being 1.7 times larger ±10 % than the inner diameter (d1) of the spray nozzle (2E) in such a way as to enable the inventive nozzle to be supplied under a medium pressure.

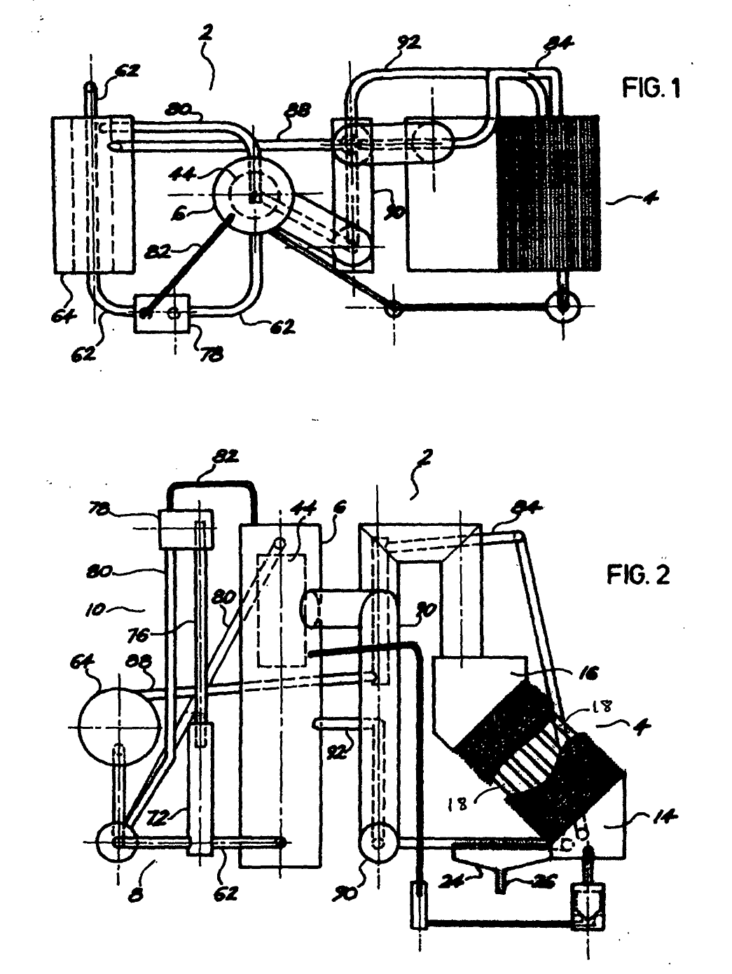

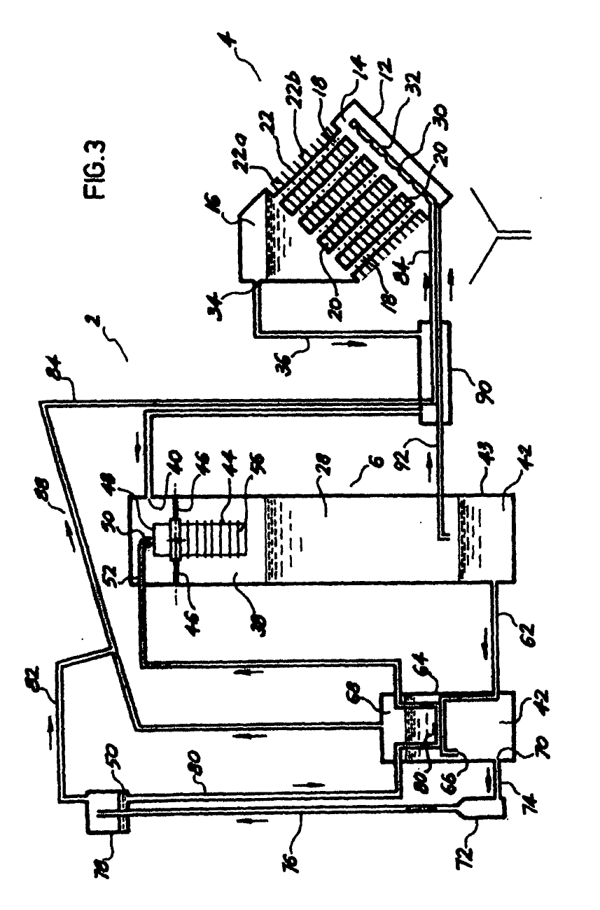

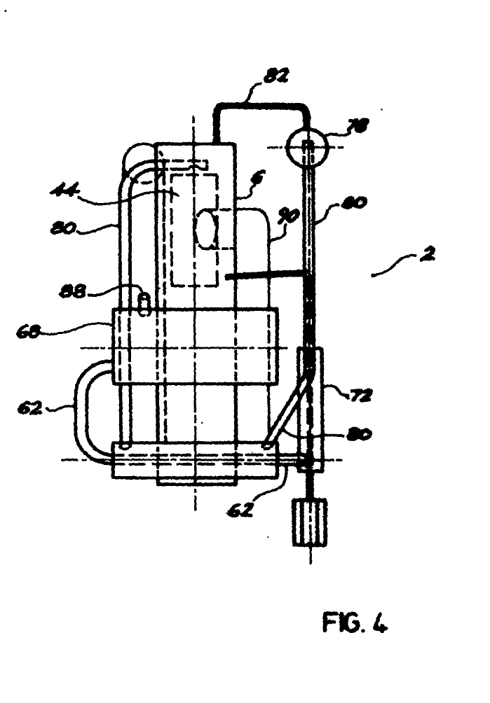

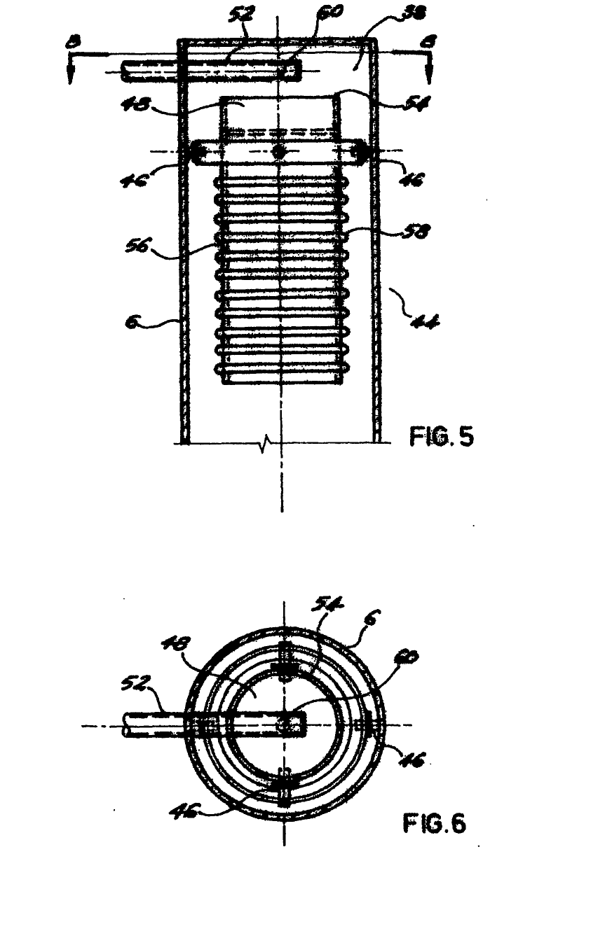

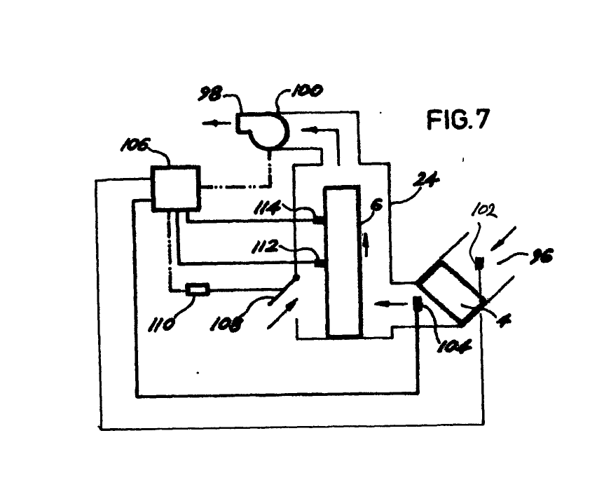

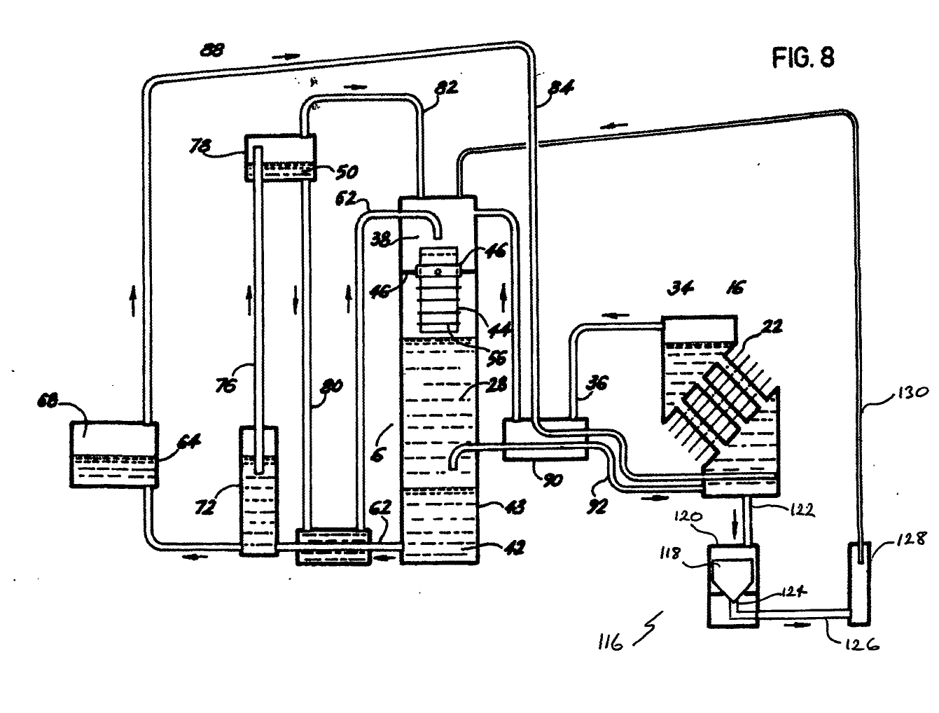

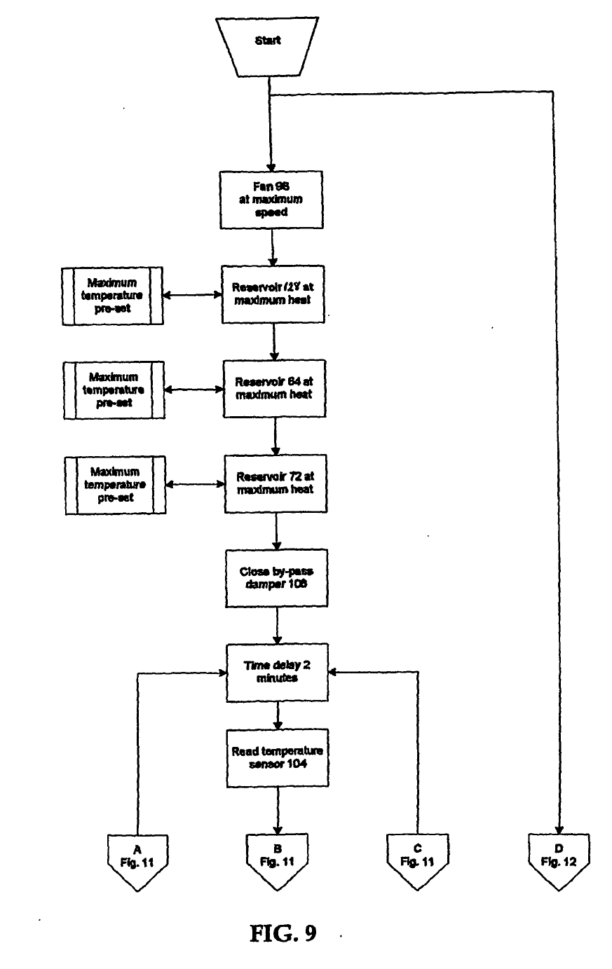

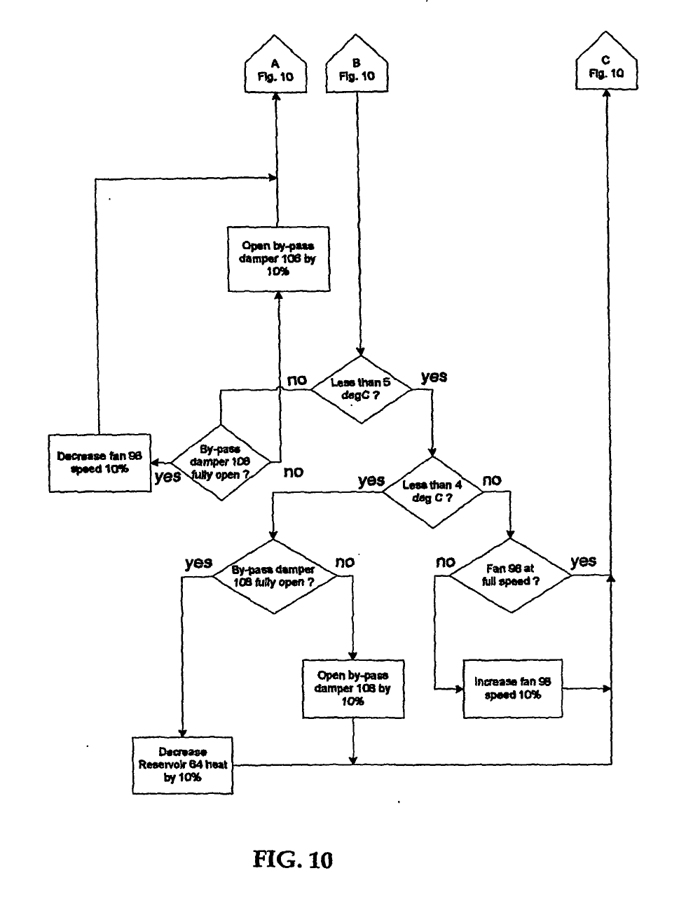

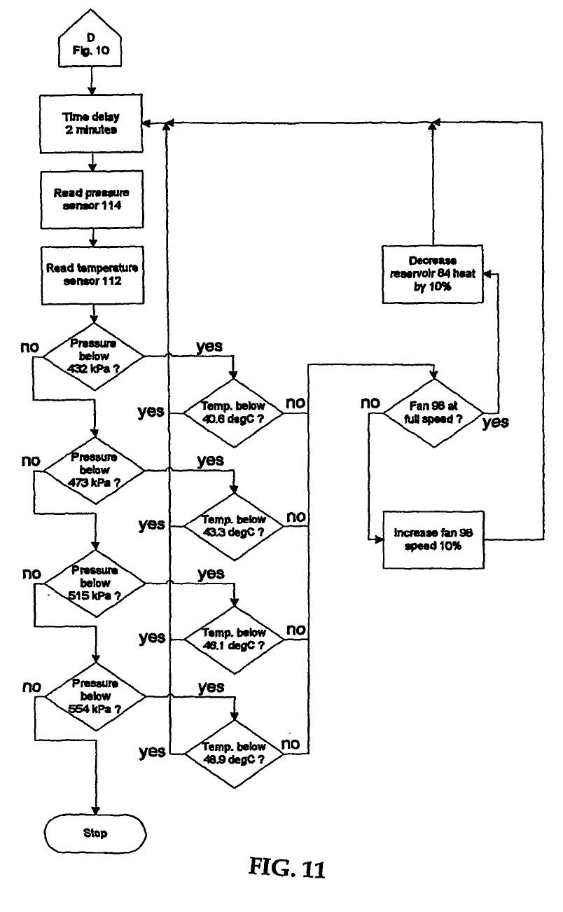

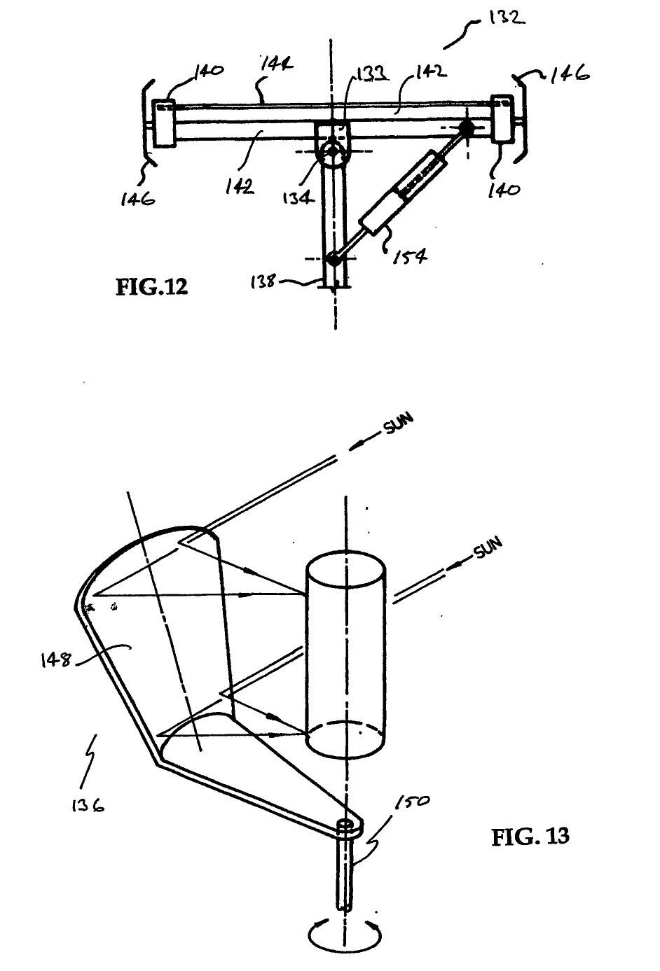

The present invention relates to a nozzle with a rotating jet of the type constituted by a stationary body delimiting an open cavity receiving an injector.

It relates more particularly to a nozzle with a rotating jet of the mentioned type, of which one end of the injector is driven with circular movement about a pivot of the body under the force of water with tangential flow acting on said injector, whilst the other end of this injector, provided with a spray nozzle, is disposed in an opening of the cavity in the form of a concave seat permitting precessional movements of the injector.

Such nozzles can particularly be used in the case of spraying installations. Until now, these nozzles with a rotating jet could not be supplied with medium pressure fluids because of the dimensional characteristics of these nozzles.

An object of the present invention is thus to provide a nozzle with which the dimensional characteristics permit supply of such a nozzle by means of a fluid flow under medium pressure, which is to say having a pressure generally comprised between 20 and 60 bars.

To this end, the invention has for its object a nozzle of the mentioned type, characterized in that the internal diameter of the spray nozzle is comprised within the range 2.8 to 6 mm whilst the smallest internal diameter of the seat is comprised within the range of 4 to 11.5 mm, the internal diameter of the seat being 1.7 times greater than the internal diameter of the spray nozzle ±10%, so as to permit medium pressure supply of the nozzle.

The invention will be better understood from a reading of the following description of embodiments, with reference to the single FIGURE, which shows a cross-sectional view of a nozzle according to the invention.

As mentioned above, the nozzle with rotating jet, called a rotanozzle, according to the invention, indicated generally at 1, is more particularly adapted to be installed in medium pressure pumping installations. This nozzle is constituted by a stationary body 2A of generally truncated conical shape, delimiting a open cavity 2B receiving an injector 2C. This injector 2C is basically in the form of a cylindrical body provided with an axial through conduit. One end of the injector 2C is driven with circular motion about a pivot 2D of the body 2A under the force of tangential water flow acting on said injector 2C. The other end of this injector 2C is provided with a spray nozzle 2E. The spray nozzle 2E has the shape of a tubular body provided with an axial through conduit. One end of this body is enlarged to form a convex spray nozzle head. The proximal surface of this enlargement constitutes an axial abutment during ensleeving of the spray nozzle 2E in the axial through conduit of the injector 2C. This end of the injector 2C, provided with a spray nozzle 2E with a convex head, is disposed in the opening of the cavity 2B shaped as a concave seat 2F permitting the precessional movements of the injector.

As the spray nozzle 2E, adapted to come into bearing against the walls of the concave seat 2F, comprises rounded portions giving the head of the spray nozzle a generally semispherical shape, the movements of the spray nozzle 2E within the seat 2F are facilitated.

In a manner characteristic of the invention, the internal diameter d1 of the spray nozzle 2E is comprised within the range 2.8 to 6 mm, whilst the smallest internal diameter of the seat 2F is comprised within the range 4 to 11.5 mm. Thus, the smallest internal diameter d2 of the seat is 1.7 times greater than the internal diameter d1 of the spray nozzle, ±10%, so as to permit a medium pressure supply of said nozzle.

The seat 2F is provided by means of a piece connected in the opening of the cavity 2B, this opening of the cavity 2B constituting the outlet orifice of the jet. The seat 2F has the shape of a semispherical cup open at its base to delimit a passage for the outlet of the fluid flow, the diameter of this outlet passage for fluid flow of the seat corresponding to the smallest internal diameter d2 mentioned above.

In the illustrated example, the seat 2F has the shape of a semispherical cup, the bottom of the semispherical cup opening into a second cavity of generally semispherical shape, the bases of the half spheres being tangent so as to delimit a passage for fluid in the general shape of an hourglass.

The spray nozzle 2E and the seat 2F are made of a material such as carbide, of higher hardness than that of the materials constituting the body 2A and the injector 2C of the nozzle, so as to reduce wear of the assembly.

1-4. (canceled)

5. Nozzle (1) with a rotating jet of the type constituted by a stationary body (2A) delimiting an open cavity (2B) receiving an injector (2C) whose one end is driven with circular motion about a pivot (2D) of the body (2A) under the effect of water pressure with tangential flow acting on said injector (2C) whilst the other end of this injector (2C), provided with a spray nozzle (2E), is disposed in the opening of the cavity (2B) in the form of a concave seat (2F) permitting the precessional movements of the injector, characterized in that the internal diameter (d1) of the spray nozzle (2E) is comprised within the range of 2.8 to 6 mm, whilst the smallest diameter (d2) of the seat (2F) is comprised in the range of 4 to 11.5 mm, the smallest diameter (d2) of the seat (2F) being 1.7 times greater, ±10%, than the internal diameter (d1) of the spray nozzle (2E) so as to permit medium pressure supply of said nozzle.

6. Nozzle (1) with a rotating jet according to claim 5,
characterized in that the spray nozzle (2E) and the seat (2F) are made of a material, such as carbide, of hardness greater than that of the materials constituting the body (2A) and the injector (2C) of the nozzle, so as to reduce wear of the assembly.

7. Nozzle (1) with a rotating jet according to claim 5,
characterized in that the seat (2F) has the shape of a semispherical cup open at its base to delimit a passage for the outlet of the fluid flow, the diameter of this outlet passage for the fluid flow of the seat corresponding to the smallest internal diameter (d2) comprised within the range of 4 to 11.5 mm.

8. Nozzle (1) with rotating jet according to claim 5,
characterized in that the seat (2F) is provided by means of a piece connected in the opening of the cavity (2B), this opening of the cavity (2B) constituting the outlet opening of the medium pressure jet of the nozzle.

9. Nozzle (1) with a rotating jet according to claim 6,
characterized in that the seat (2F) has the shape of a semispherical cup open at its base to delimit a passage for the outlet of the fluid flow, the diameter of this outlet passage for the fluid flow of the seat corresponding to the smallest internal diameter (d2) comprised within the range of 4 to 11.5 mm.

10. Nozzle (1) with rotating jet according to claim 6,
characterized in that the seat (2F) is provided by means of a piece connected in the opening of the cavity (2B), this opening of the cavity (2B) constituting the outlet opening of the medium pressure jet of the nozzle.

11. Nozzle (1) with rotating jet according to claim 7,
characterized in that the seat (2F) is provided by means of a piece connected in the opening of the cavity (2B), this opening of the cavity (2B) constituting the outlet opening of the medium pressure jet of the nozzle.
